(19) United States
(12) Patent Application Publication
(10) Pub. No.: US 2007/0171082 A1
(43) Pub. Date: Jul. 26, 2007

(54) FLASHLIGHT WITH SOS AND ENERGY SAVER FEATURES

(76) Inventor: Michael A. Melnik, Deerfield, MA (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/682,006

(22) Filed: Mar. 5, 2007

Related U.S. Application Data
(63) Continuation-in-part of application No. 11/104,793, filed on Apr. 13, 2005.
(60) Provisional application No. 60/561,695, filed on Apr. 13, 2004.

(51) Int. Cl. G08B 13/00

(52) U.S. Cl. 340/574

(57) ABSTRACT

A self-powered flashlight includes a pair of end lights and a ring of circumferential lights which are selectively energized by a pushbutton switch. The module includes a housing and an inner electronic module. The inner module includes a display for displaying time and temperature as well as a transceiver such as a cell phone and GPS unit which are activated by a switch. The switch permits selection of one of a warning mode, an alert mode or an SOS mode.

### CROSS-REFERENCE TO RELATED APPLICATIONS

This application is a continuation-in-part from U.S. patent application Ser. No. 11/104,793, filed Apr. 13, 2005, which claims priority of U.S. Provisional patent application Ser. No. 60/561,695 filed Apr. 13, 2004, both of which are incorporated herein by reference.

### FIELD OF THE INVENTION

The invention relates to a safety module having lights that are selectively operable to indicate a warning or a safety alert. More particularly, the invention relates to a safety module which may be mounted to a flashlight and provide warning signals for oncoming traffic.

### BACKGROUND OF THE INVENTION

It is known to use flashlights or lanterns to illuminate pathways when walking at night. However, when walking in urban areas where there is traffic approaching from behind the user, a flashlight provides no indication of the presence of the user. Accordingly, it would be advantageous to provide a module for use with a flashlight that is easily seen from all directions to warn approaching vehicles.

### SUMMARY OF THE INVENTION

The invention is directed to a self-contained module having a cover and inner module containing two groups of lights. One group is a pair of lights which are directed through a top end of a covering. The group of lights is formed in a ring and is visible through a cylindrical sidewall of the covering. A pushbutton switch is operable to direct a control circuit to display the lights in preselected modes. The electronic module is also includes an electronic display, a clock and temperature device. Additionally, the module can be provided with a transceiver or cell phone type device and a GPS activated by an emergency switch. The module is mounted to a flashlight with an adapter. The module contains a power source and may be used separately from the flashlight.

### BRIEF DESCRIPTION OF THE DRAWINGS

FIG. 1 is a perspective side view of a module adapter and a conventional flashlight;

FIG. 2 is a perspective view of the safety module;

FIG. 3 is an exploded side view of the safety module showing the housing, electronic module and battery pack;

FIG. 4 is a side view of an opposite side of the inner module;

FIG. 5 is a side view of a first alternative preferred embodiment of the safety module of the invention;

FIG. 6 is a partial perspective view of the end of the first alternative preferred embodiment of the invention;

FIG. 7 is a perspective view of a different embodiment of the invention;

FIG. 8 is a perspective view of a safety module containing a cell phone;

FIG. 9 is a perspective view of a holder for the invention;

FIG. 10 is a perspective view of a holder and a storage container for the invention; and

FIG. 11 is a perspective view of a holder for the invention.

### DETAILED DESCRIPTION OF THE PREFERRED EMBODIMENTS

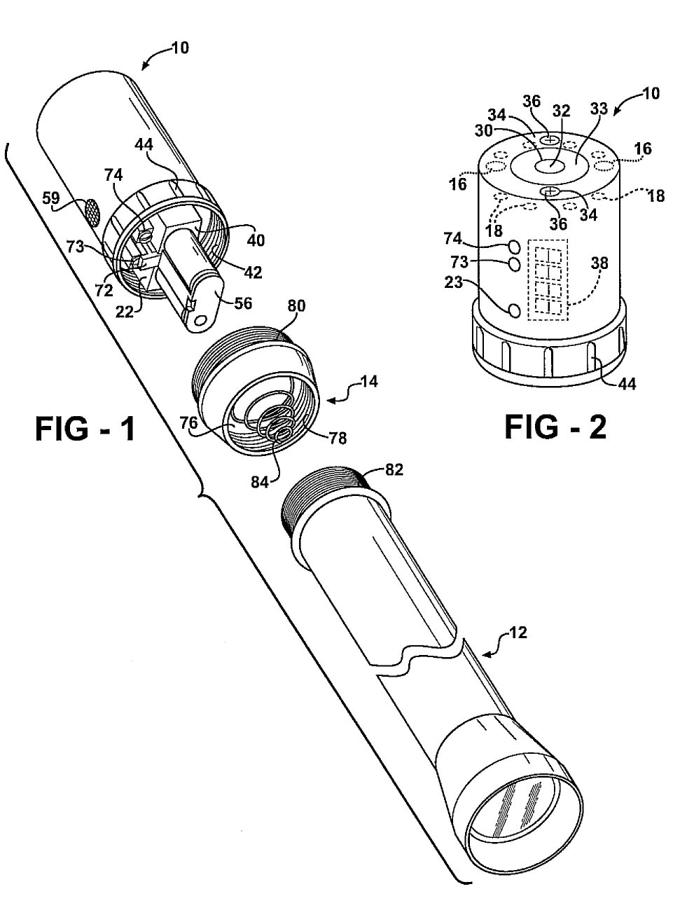

As shown in FIGS. 1 and 2, a first preferred embodiment of the invention is a safety warning module 10 mounted to a conventional flashlight 12 by an adapter 14. Although shown mounted to the flashlight 12, the module is self-contained and may be used separately or mounted to a variety of devices, such as wheelchairs, bikes, etc. The safety module has two groups of lights which may be selectively operated in predetermined modes to provide alerts or warnings. The module is also provided with electronic safety items as discussed herein. One group of lights is a pair of bright lights 16 and another group is of eight smaller lights 18 which are disposed in a ring.

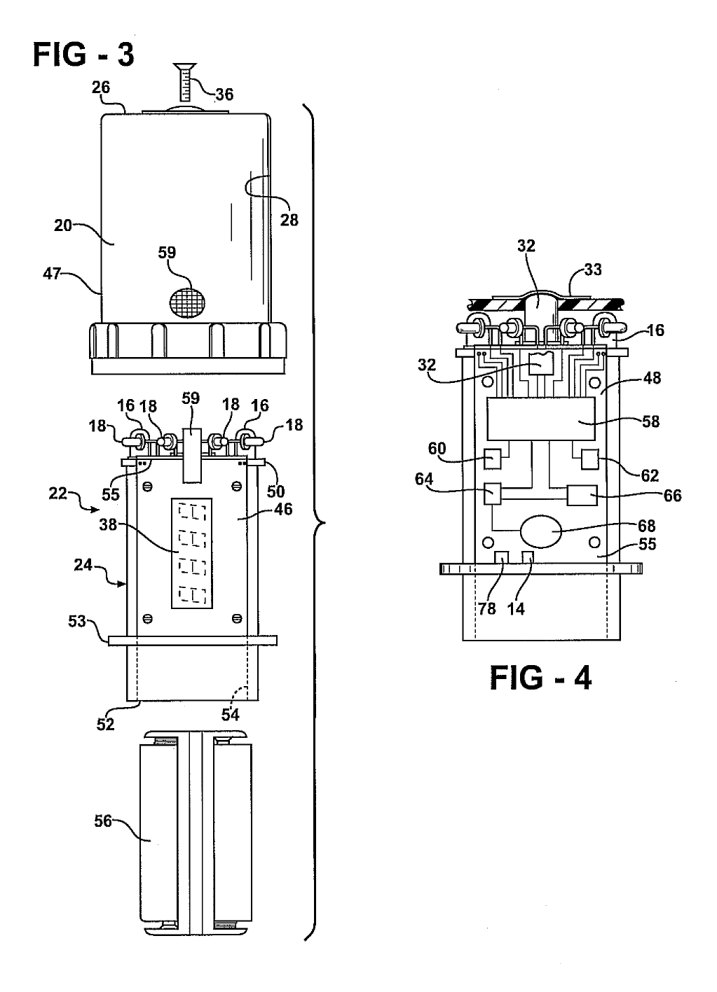

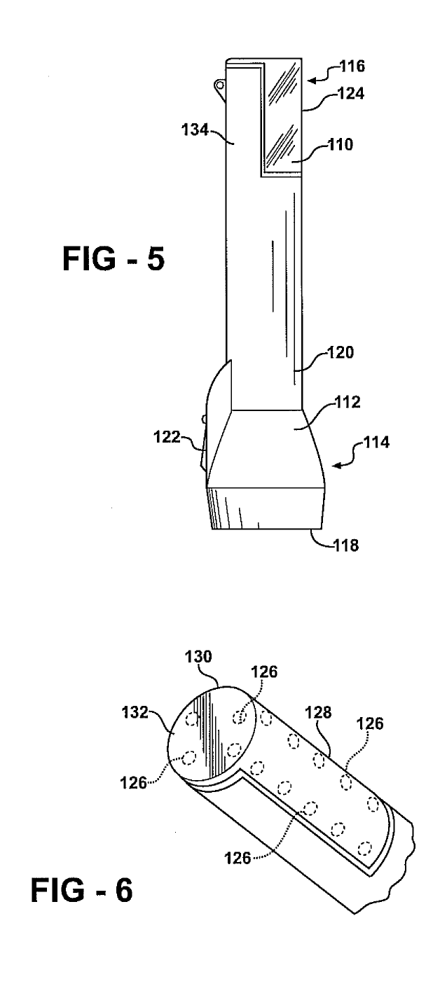

As shown best in FIG. 3, the module 10 includes an inner module 22 mounted in a cup-shaped housing 20. The inner module 22 includes a rectangular base 42 to which electrical components are mounted. As shown in FIGS. 3 and 5, the base 42 is generally in the form of a rectangular box having two wide sidewalls 46, 48, a top end 50, and a lower end 52. The lower end 52 has an opening 54 in the opposite end. The opening 54 is formed to receive a battery pack 56 which is slid into the opening 54. The module is thus self-powered. A solar cell to recharge the battery may be mounted to the housing. A circular flange 53 is formed to extend to an inner surface of the housing to position the inner module within the housing.

As shown in FIGS. 1, 2 and 3, the housing 20 has a generally flat top surface 26 and cylindrical wall 28 molded of transparent material. In the preferred embodiment, the housing 20 is formed of a red acrylic. The top surface 26 has a center hole 30 for receiving a pushbutton switch 32. A pair of apertures 34 are formed for screws 36 to secure the inner module 22 to the housing 20. The housing is transparent so that the lights 16, 18 and a display 38 may be viewed through the housing 20. The cylindrical wall 28 has open end 40 with internal threads 42 for mounting to the adapter 14. Ribs 44 are formed on an outer surface of the end 40 to facilitate mounting of the housing to the adapter. When a transceiver is incorporated into the unit, the housing 20 has a hole in the side for an emergency switch 47 to operate a phone and several small openings 59 covered on the inside with a water-resistant membrane to permit sound to be transmitted to and received from a microphone/speaker.

As shown in FIGS. 2 and 3, the pair of end lights 16 and eight side lights 18 are mounted to a board 55 positioned on the top end 50 of the base. The lights 16, 18 are preferably in the form of red light emitting diodes (LEDs) and are mounted to be visible through the housing 20. The end lights 16 are much brighter and visible through the top surface 26 so that the module can be clearly seen from behind. The eight side lights 18 are spaced around the circumference of the top surface 50 in a ring to be visible out of both from the top surface 26 but also through the cylindrical wall 28. The second group of lights 18 can thus be seen from any direction. The lights 16, 18 preferably have high visibility and require low power such as LEDs. The switch 32 is a pushbutton switch which can be held for discrete periods of time to operate and switch various components of the module 10. The switch may be provided with a cover to make the module 10 watertight. The pushbutton switch 32 is mounted to extend through the center hole 30 to operate the lights and other components of the module 10 as discussed more fully below. A pair of spacers 59 are provided to space the top end 50 from the top surface of the covering to provide space for the lights 16, 18 and switch 32.

As shown in FIG. 4, the control circuit 58, as well as a clock 60 and electrical thermometer 62 are mounted to a board 55 which is mounted on sidewall 48. The clock and thermometer are connected to the control circuit and to the display 38 which is mounted on the other side 46. Additionally, a transceiver 64 such as used in a cell phone and a GPS unit 66 may be mounted on the side 48. A microphone/speaker 68 for the transceiver is also mounted to the side 48 to be aligned with openings 59 formed in the housing. An emergency switch 47 is mounted in the housing 20 to operate the transceiver. Other accessories such as a digital camera, biological and chemical sensors, as well as heart and blood pressure monitors may be added. The lights 16, 18 and switch 32 are electrically connected to the control circuit 58.

The control circuit 58 includes a microchip which is programmed to act in response to the switch 32 to cycle through a number of modes of operation. One short press of the pushbutton places the module in a steady mode where the two end lights 16 are energized. This mode is particularly useful for walking at night when using a flashlight. When the flashlight is directed to the ground ahead of the user, the end lights 16 are visible from behind to warn traffic of the presence of the user. A second short press directs the controller to the alert mode where the end lights 16 and side lights 18 flash sequentially. Another short press cycles the controller 58 to an SOS mode in which all of the lights 16, 18 will flash an SOS pattern to alert individuals as to an emergency condition.

The emergency switch 47 directs the controller 58 to move to an emergency mode at which time the UPS unit 66 is activated and the transceiver 64 is activated. The transceiver 64 is programmed to dial 911. After connecting to 911, the user can speak through the openings 59 in the housing to the microphone/speaker 68 to an emergency operator to provide the emergency operator with the nature of the emergency. At the same time the display 38 will provide the latitude and longitude coordinates which the user can provide to the emergency operator. In some transceivers 14 the GPS information will be accessible directly by the emergency personnel.

As shown in FIG. 2, a contact switch 23 for initiating adjustment of the clock 60 is positioned at the bottom end of the base. Holding the contact switch 23 for two seconds will energize the adjustment mode. A pair of mode buttons 73, 74 are provided to change the adjustment mode. One button is provided to change the hour, the other the minute. A time and temperature display mode is activated by holding the pushbutton of the switch 32 for approximately one second. The time and temperature will display in alternate form on the display 38 in all modes. The battery power is also displayed through the monitor along with a sound indicating low battery strength.

As shown in FIG. 1, the adapter 14 is circular with a radially extending wall 76 separating a first threaded portion 78 and a second threaded portion 80. The first threaded portion 78 is formed to engage threads 82 on the end of the flashlight 12 to which an end cap (not shown) is normally mounted. The adapter 14 is mounted to the flashlight instead and is provided with a spring 84 to connect the batteries (not shown) of the flashlight 12.

If the module is installed on a flashlight not using the end cap for access to the batteries, it will not be necessary to use the coil spring on the adapter. In some cases, the adapter may have an attachment device such as a sleeve which can be tightened over the end of the flashlight. A number of suitable attachment arrangements are within the contemplation of the invention. Additionally, it is not necessary to mount the module 10 on a flashlight. The module 10 may be mounted to a tubular handle which could be carried in the same fashion as a flashlight. The tube may be formed so that it is strapped onto the arm or leg of the user or to other devices such as vehicles, wheelchairs and the like. Finally, the module may be separate and used as a standalone module. The module is self-powered and may be placed on a window ledge or on the dashboard of a car to indicate a problem.

A first preferred alternative embodiment of the safety module 10 is shown in FIGS. 5-6 as part of a flashlight 112. This embodiment is a device generally in the form of a flashlight having both a conventional flashlight assembly 114 at one end and an emergency flashing or non-flashing warning light 116 at the other end. The safety module may be handheld for walking, liking, or performing certain jobs at night such as traffic direction, etc. or as a safety lamp placed on a surface or the ground.

The flashlight assembly 114 has a lens bolder having a flat surface 118 permitting the flashlight to be placed on the flat surface to support a handle 120 in a vertical position with the warning light at the top. The handle portion has a switch 122 and a warning light shield 124 at the other end. A warning light assembly is mounted to the body beneath the shield 124.

The warning light assembly includes a lens 128 covering one or more highly visible flashing lights 126 such as an LED. The lens has a semi-cylindrical portion 130 extending to a disk portion 132 which extends normally from the semi-cylindrical portion 130 to cover the end of the flashlight. The semi-cylindrical portion extends under a shield portion 134 of the handle to cover a cavity containing the warning light bulb or LEDs. Light is permitted to pass through both the disk and the semi-cylindrical portion of the lens.

The handle 120 contains a battery compartment as a conventional flashlight. The flashlight end is removable to access the battery compartment. The switch is positioned on the opposite side of the light shield 124 adjacent the flashlight assembly. The switch has a slide which moves longitudinally from the front through three positions from “off”: (1) flashlight only, (2) both flashlight and safety light, and (3) safety light only.

When used for walking etc. at night, the flashlight is held in a conventional position with the handle and flashlight assembly angled at the ground ahead of the walker. Because the flashlight is held at an angle with respect to horizontal, the disk and semicircular portion of the lens are visible to vehicles approaching from behind and on both sides of the user. The shield portion 134 of the handle blocks light from the warning light from the user.

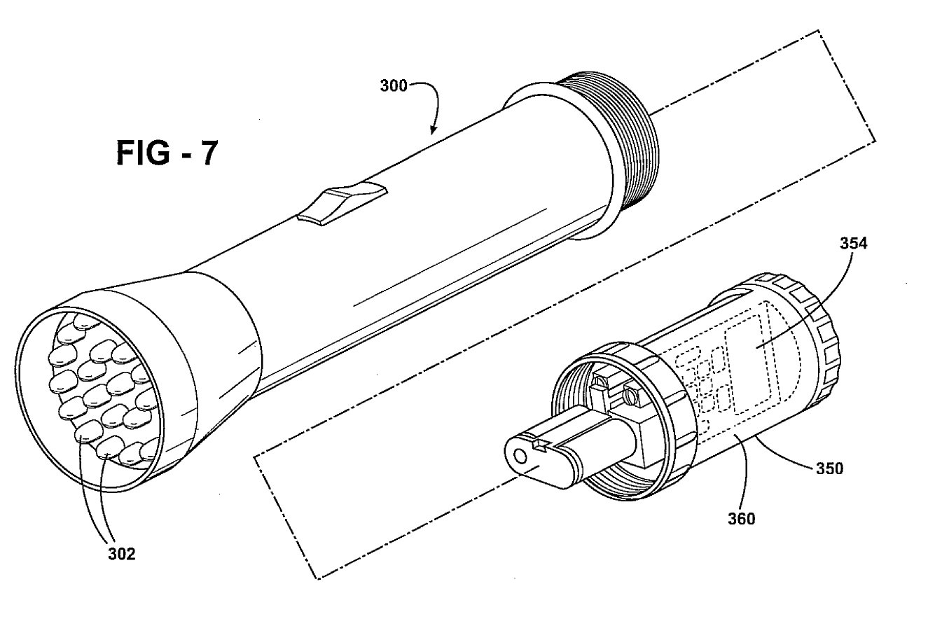

A different embodiment is illustrated in FIGS. 7-9, In this embodiment, a flashlight 300 with a safety module 350 can be removably attached to a holder 200. The flashlight 300 can include LED lights 302 as shown in FIG. 7 or in the alternative include an incandescent light bulb (not shown) as used in traditional flashlights. The holder 200 includes a holder charger connection 210 that affords for electrical communication between said holder 200 and said flashlight 300 through a flashlight and safety module charger connection 310. In addition, the holder 200 includes a power connection 220 which affords for transmittance of electrical power to said holder and subsequently to said flashlight 300 and safety module 350 assembly. In this manner, the holder 200 affords for the charging/recharging of a battery pack within said safety module 350 similar to the battery pack 56 within module 10 as shown in FIGS. 1 and 3. In addition, holder 200 can afford for the charging/recharging of a battery pack within flashlight 300 simultaneously with charging/recharging of the battery pack within the safety module 350.

It is appreciated that the present invention includes a flashlight 300 and safety module 250 operable with only one battery pack. For example, if necessary due to a flashlight battery failure, the flashlight 300 can use the battery power from the battery back within the safety module 350. The present invention also includes the ability for the opposite, that is, the safety module 350 can use battery power from the battery pack within the flashlight 300 if necessary. In the alternative, the flashlight 300 and safety module 350 is designed and produced with only one battery pack. It is also appreciated that the flashlight 300 and safety module 350 can be manufactured as one unit, or as more than one unit as illustrated in FIG. 7.

The safety module 350 can include a transceiver unit 351, unit LED lights 358 and a waterproof clear panel 360. It is appreciated that the transceiver unit 351 resembles a cell phone in FIGS. 7-9, however the transceiver unit 351 can be any type of transceiver unit known to those skilled in the art, illustratively including a cell phone, a walkie-talkie, CB radio and the like. The transceiver unit 351 can include a keypad 352 and a display 354. Depressing an individual pad on the keypad 352 results in the respective number and/or function being displayed on the display 354 and affords for placing a telephone call. The keypad 352 can include a switch (not shown) that affords for the energizing of the LED lights 358. In the alternative, said switch can be located at a different location on the safety module 350 and/or flashlight 300. The keypad 352 can also include a single emergency service button or pad 355. The emergency service button 355 affords for a one button call to an emergency response station, safety service, emergency response personnel, provider and the like.

The safety module 350 of the present invention can include other safety features. For example, the safety module 350 and/or the transceiver unit 351 therein can include an electronic storage device wherein first aid, medical and/or survival information can be stored and subsequently recalled for display on the display 354, The type and amount of information stored within said storage device can be determined and controlled by the manufacturer and/or the user of the safety module 350. It is also appreciated that transceiver unit 351 is operable to connect to the internet and view web pages, emails and the like. The transceiver unit 351 is also operable to download and/or upload information to/from the internet and to receive an extreme weather emergency alert automatically and provide said alert to a user in visual and/or audible form. If a user is not present when such information is received by the unit 351, said unit can include a message light (not shown) to indicate that an urgent message has been received and awaits the user for listening and/or viewing. The transceiver unit 351 can also include a voice answering and/or text answering service for recording messages left by a third party.

The display 354 affords for a display through which all electronic information is available for viewing by a user, illustratively including a number or function representative of a pad pressed on transceiver unit keypad 352, the time, the temperature, a GPS position, a text message, a remaining battery power indication and combinations thereof. The transceiver unit display 354 also affords for the display of other electronic information provided by the safety module 350. A control circuit similar to control circuit 58 shown in FIG. 4 can be included providing an electrical connection between said switch, transceiver unit 351, LED lights 358 and other components of the safety module 350. Said control circuit is operable to energize said LED lights according to one of a plurality of predetermined modes.

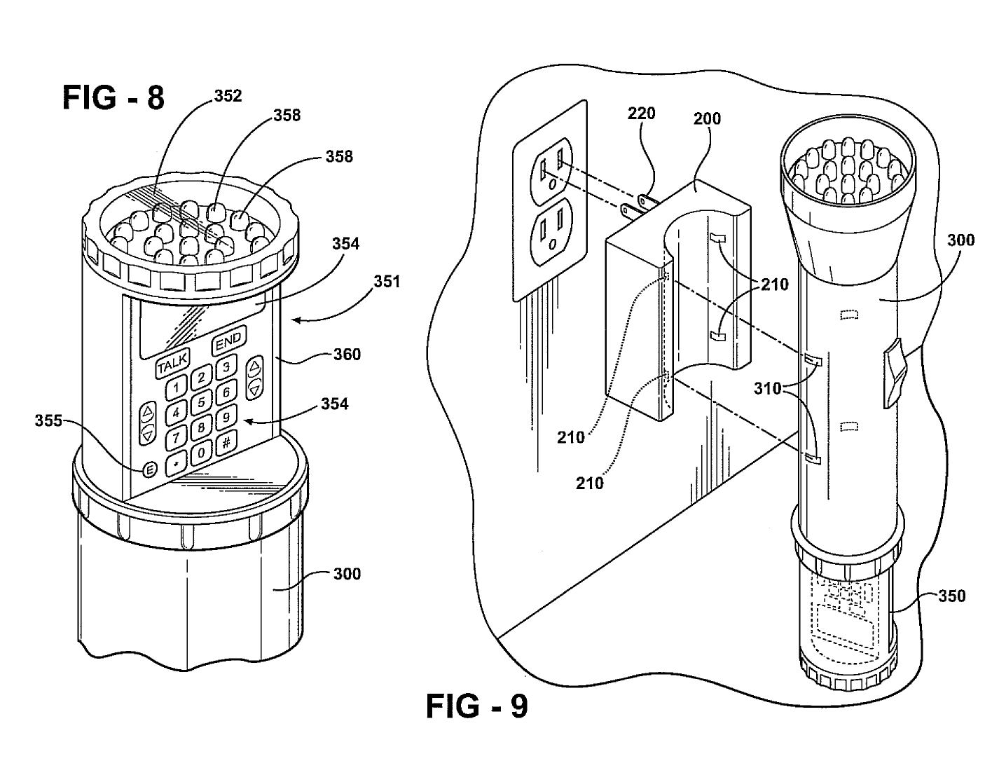

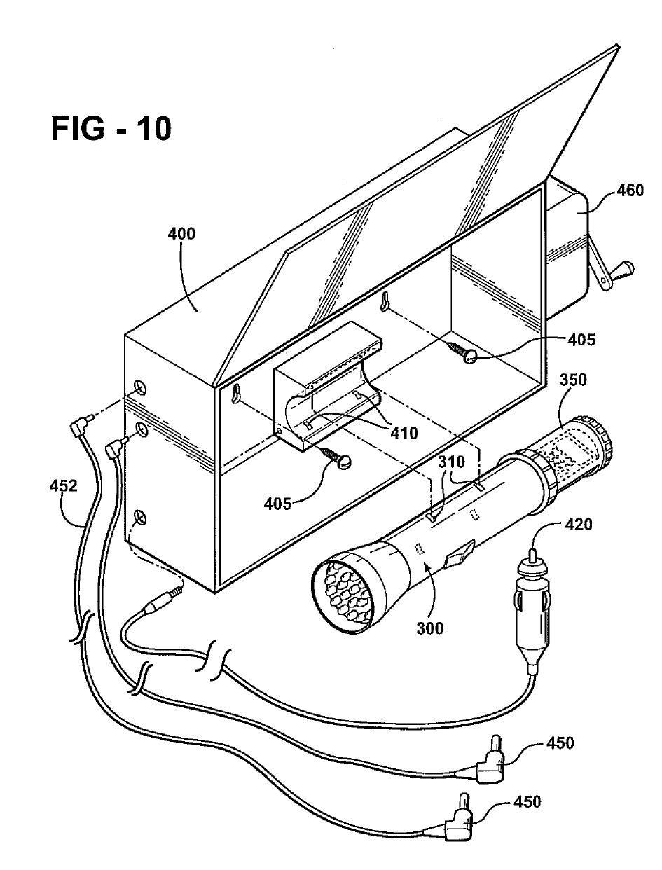

The LED lights 358 are similar to the LED lights 18 shown in FIGS. 1 and 2. As shown in FIG. 8, LED lights 358 are oriented in a direction generally parallel to a longitudinal axis of the flashlight 300 and are covered by a transparent end surface 352. In the alternative, part or all of the LED lights 358 can be oriented in a direction that is not generally parallel to the longitudinal axis of the flashlight 300 and may or may not be covered by transparent end surface 352. For purposes of the present invention, the term generally parallel is defined as being parallel or within 15 degrees of being parallel to a respective direction or axis. The LED lights 358 are operable to remain energized continuously, flash on or off, or flash with the sequence representative of a SOS signal. Preferably, the LED lights 358 are red LED lights.

The waterproof, clear panel 360 affords for protection of the keypad 352 and display 354 from physical impact from an object and environmental elements illustratively including water, dirt, dust, sunlight, and combinations thereof. The panel 360 is operable to twist open and allow access to the transceiver unit 351. For example, FIGS. 7 and 9 illustrate the panel 360 in a closed position wherein the keypad 352 and display 354 are covered. In contrast, FIG. 8 illustrates the panel 360 in an open position wherein access to the keypad 352 and display 354 is afforded. In a different embodiment, the panel 360 can include a hinge which affords for panel 360 to swing open and allow access to the transceiver unit. In still a different embodiment, the clear panel 360 can be attached to the safety module 350 using a snap fit and/or clips and can be completely removed from the safety module 350 to allow access to the transceiver unit 351.

As illustrated in FIG. 9, the holder 200 with the power connection 220 can be attached and/or connected to a typical 120 volt-60 Hz electrical outlet. In the alternative, the holder 200 with power connection 220 can be adapted to be operable with any appropriate power source, illustratively including a power source located in or on an automobile, a truck, a tractor, a boat, an airplane and an all-terrain vehicle.

Turing to FIG. 10, the flashlight 300 and safety module 350, as disclosed with respect to FIGS. 7-9, is shown with a storage container 400. The storage container 400 includes a charger connection 410 and a power connection 420. Similar to the holder 200, the storage container 400 affords for the charging/recharging of the safety module 350 and/or flashlight 300. In addition, the storage container 400 affords for the protection of the flashlight 300 and safety module 350 when not in use from physical impact from an object and environmental elements such as rain, oil, dirt, dust, sunlight, and combinations thereof. The storage container 400 also includes fasteners 405. The fasteners 405 afford for the mounting of the container 400 to a suitable structure and/or surface (not shown) that will support container 400. Although the fasteners 405 shown in FIG. 10 illustrate screws for mounting the container 400, the present invention includes releasable attachment means for the container 400 using clips, hangers and the like. The container 400 can be permanently or non-permanently attached to any suitable location that provides an adequate power supply, illustratively including a home, an automobile, the trunk of an automobile, a tractor, a boat, an airplane and an all-terrain vehicle.

One embodiment of the container 400 includes a handle (not shown) that affords carrying of the container 400 with or without the flashlight 300 and safety module 350 within. In this manner, the container 400 affords protection of the flashlight 300 and safety module 350 when mounted, not mounted and/or while being transported, carried, etc. A different embodiment of the container 400 includes at least one additional charging outlet 450 which affords for the charging/recharging of batteries within electronic equipment illustratively including cell phones, personal digital assistance (PDA) devices, laptop computers and the like. In addition, the container 400 is operable to supply power to a battery charger for recharging rechargeable AA batteries, AAA batteries, etc. It is appreciated that the container 400 with the at least one charging outlet 450 can be a standalone charger/recharger of electronic equipment and/or batteries.

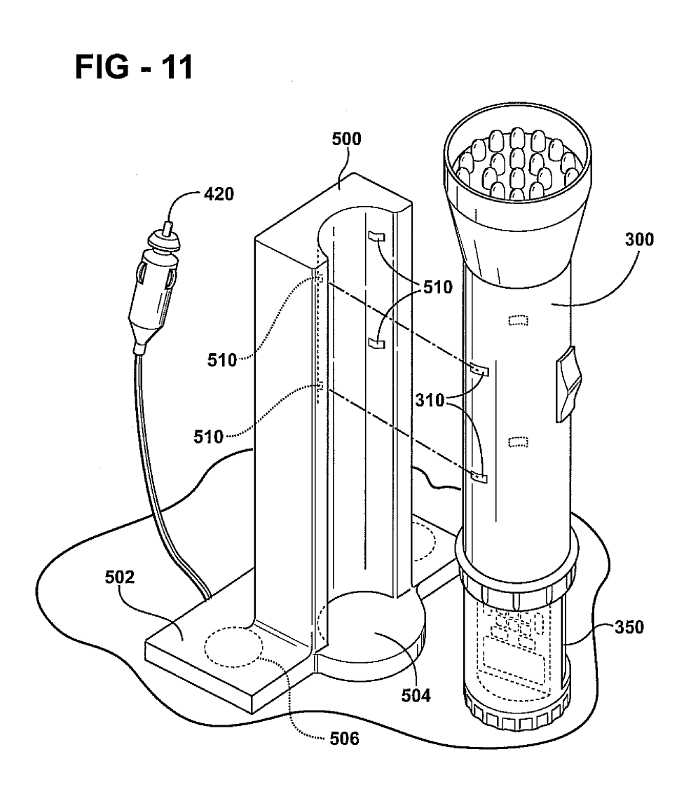

Still yet another embodiment of the present invention is illustrated in Figure 11 wherein a stand-up holder 500 is provided to charge/recharge the flashlight 300 and/or safety module 350. Similar to the holder 200, the stand-up holder 500 includes charger connection 510 and a power connection 520 which are operable as disclosed for the charger connection 210 and power connection 220 above. Unlike the holder 200, the stand-up holder 500 includes a base 502 with at least one fastener 506 for mounting said holder 500 on a surface illustratively including a motor vehicle dashboard or console. The fastener 506 as illustrated in FIG. 11 is a suction cup, however other fasteners known to those skilled in the art can be used, illustratively including hook and loop fasteners, adhesives, tape, screws, nuts and bolts and combinations thereof. The stand-up holder 500 preferably includes a base 504 which can support the flashlight 300 and safety module 350 when said flashlight and safety module are placed or attached to said holder 500. It is appreciated that the holder 500 can include an additional charging outlet similar to the at least one charging outlet 450 in FIG. 10. The holder 500 with at least one charging outlet can serve as a standalone charger/recharger or electronic equipment and/or batteries.

Thus disclosed is a novel safety warning module which can be installed on a conventional flashlight providing a warning to approaching vehicle in the presence of a pedestrian, jogger, bike rider or the like. The module provides a shielded light which flashes brightly in the direction of the approaching vehicles yet is occluded from the user's eyes. A number of electronic accessories may be provided.

1. A flashlight comprising:
a housing having a light;
a transceiver unit, said transceiver unit having a key pad and a display;
a switch operable to selectively actuate said light and said transceiver; and
a power source contained within said housing.

2. The flashlight of claim 1 further comprising a control circuit, said control circuit connected to said switch, light and transceiver unit, and operable to energize said light according to one of a plurality of predetermined modes.

3. The flashlight of claim 1 further comprising a cover panel, said panel being transparent and being operable to cover and allow access to said transceiver unit.

4. The flashlight of claim 1, further comprising at least one additional electronic device selected from the group consisting of a thermometer, a clock, a GPS unit and combinations thereof.

5. The flashlight of claim 1, wherein said display is operable to display electronic information selected from the group consisting of a number representative of a pad depressed on said keypad, a phone number dialed to said transceiver unit, a temperature, a time, a GPS determined position, a text message, a remaining battery power indication and combinations thereof.

6. The flashlight of claim 1, wherein said transceiver unit has an emergency button, said emergency button operable to call an emergency service when depressed.

7. The flashlight of claim 1, wherein said transceiver unit has a message light, said message light operable to indicate a message has been received by said transceiver unit and awaits listening or viewing by a user.

8. The flashlight of claim 1, wherein said transceiver unit is operable to receive and transmit an extreme weather emergency alert.

9. The flashlight of claim 1, further comprising a holder, said holder operable to hold said flashlight and to connect to an outside power source, for the purpose of electrically charging said power source.

10. The flashlight of claim 9, wherein said holder is connected to an electrical source outlet.

11. The flashlight of claim 9, wherein said holder is connected to an electrical output source of an object selected from the group consisting of a motor vehicle, a boat, an airplane, a tractor, an all-terrain vehicle and combinations thereof.

12. The flashlight of claim 9, wherein said holder is a storage container, said container operable to limit exposure of said safety module to environmental elements selected from the group consisting of liquid, dirt, dust, sunlight and combinations thereof.

13. The flashlight of claim 9, further comprising at least one charging outlet operable to charge/recharge a battery.

14. The flashlight of claim 9, wherein said holder is operable as a standalone charger/recharger of a battery.

15. A flashlight comprising:
at least one light mounted to an inner module within said housing, said light visible through an end surface when energized;
a transceiver unit, said transceiver unit having a key pad and a display;
a switch operable to selectively actuate said light and said transceiver unit;
a cover panel, said cover panel operable to cover and allow access to said transceiver unit; and
a power source contained within said housing.

16. The flashlight of claim 15, further comprising at least one additional electronic device selected from the group consisting of a thermometer, a clock, a GPS unit and combinations thereof.

17. The flashlight of claim 15, wherein said display is operable to display electronic information selected from the group consisting of a number representative of a pad depressed on said keypad, a phone number dialed to said transceiver, a temperature, a time, a GPS determined position, a text message, a remaining battery power indication and combinations thereof.

18. The safety module of claim 15, further comprising a holder, said holder operable to hold said safety module and to connect to an outside power source, for the purpose of electrically charging said power source.

19. The safety module of claim 18, wherein said holder is connected to an electrical source outlet.

20. The safety module of claim 18, wherein said holder is connected to an electrical output source of an object selected from the group consisting of a motor vehicle, a boat, an airplane, a tractor, an all-terrain vehicle and combinations thereof.

21. The safety module of claim 18, wherein said holder is a storage container, said container operable to limit the exposure of said safety module to environmental elements selected from the group consisting of liquid, dirt, dust, sunlight and combinations thereof.

22. A flashlight comprising:
at least one light mounted to an inner module within said housing, said light visible through an end surface when energized;
a transceiver unit, said transceiver unit having a key pad and a display;
a switch operable to selectively actuate said light and said transceiver unit;
a cover panel, said cover panel operable to cover and allow access to said transceiver unit;
a power source contained within said housing; and
a holder, said holder operable to hold said flashlight, communicate with an external power supply and communicate with said power source within said housing.
